(19) United States
(12) Patent Application Publication
(10) Pub. No.: US 2017/0064956 A1
(43) Pub. Date: Mar. 9, 2017

(54) Medisox: Disposable Medicated Athlete's Foot Fungal Socks

(71) Applicant: Park Eugene Garnes, JR., Newville, PA (US)

(72) Inventor: Park Eugene Garnes, JR., Newville, PA (US)

(21) Appl. No.: 15/062,154

(22) Filed: Mar. 6, 2016

Related U.S. Application Data
(60) Provisional application No. 62/255,437, filed on Nov. 14, 2015.

(51) Int. Cl. A01N 43/50; B65D 85/18; B65D 33/25; A01N 25/10; A41B 11/00

(52) U.S. Cl. CPC A01N 43/50; A01N 25/10; A41B 11/004; B65D 33/25; B65D 85/187; A41B 2400/34; A41B 2400/32

(57) ABSTRACT

A wearable article comprising a water disintegratable leak-proof sock for an absorbent article compromising a water disintegratable chemical compound consisting Miconazole Nitrate 2% solution diluted using water.

A wearable article comprising a water disintegratable leak-proof sock for an absorbent article compromising a water disintegratable chemical compound consisting Miconazole Nitrate 2% solution diluted using water.

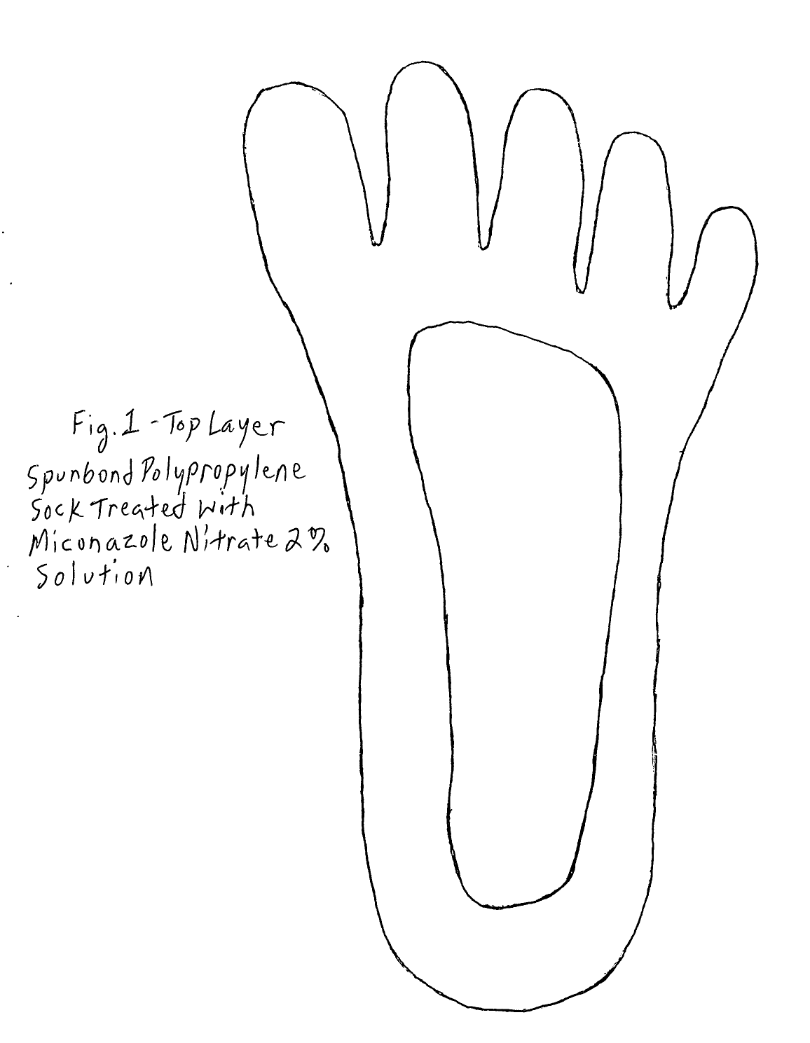

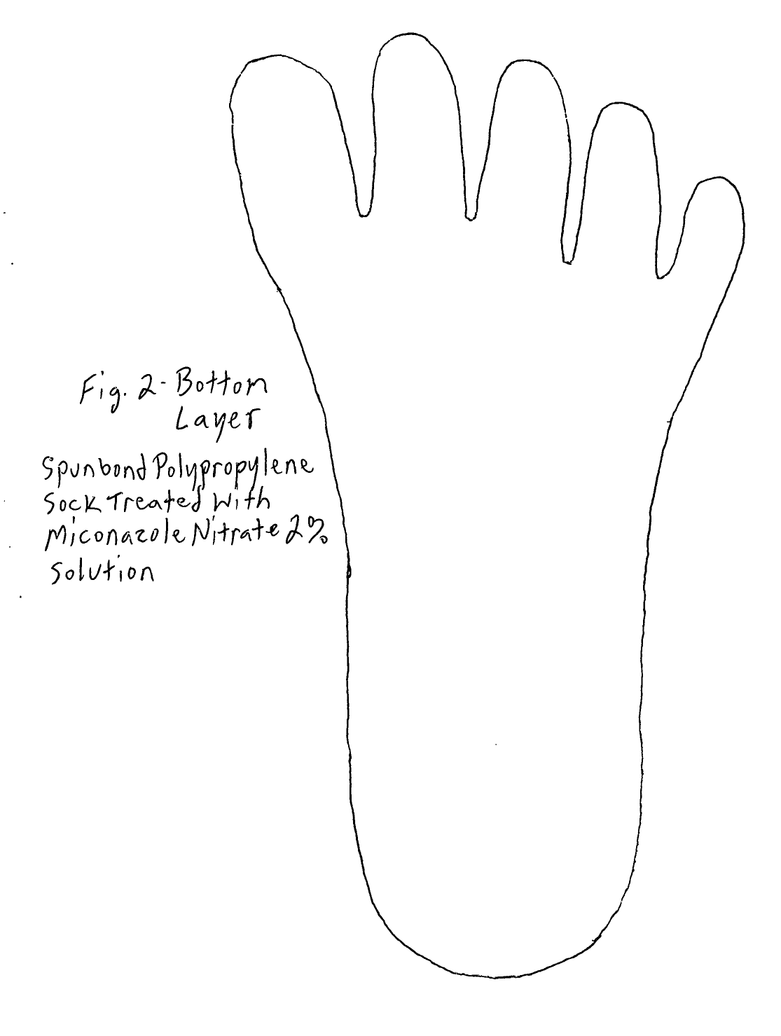

FIG. 1 Drawing is the top layer to be welded with FIG. 2 Drawing showing the bottom layer of the sock.

1. A wearable article comprising a water disintegratable leak-proof sock for an absorbent article compromising a water disintegratable chemical compound consisting Miconazole Nitrate 2% solution diluted using water. The Miconazole Nitrate solution assuming 1000 mg/100 ml=99% purity. Dilution of 2% is achieved at 20 mg of Miconazole Nitrate per liter of water. The Disposable Spunbond polypropylene fabric sock is totally submersed into the solution to saturate the fabric and allowed to air dry in a clean room environment to create the Medisox Disposable Medicated Athlete's Foot Fungal Sock.

2. This substantially spunbond polypropylene textile fabric cloth cut for foot sizes 6″ to 14″ plus narrow and wide sizes packaging made of heat sealed foil ziplock pouch side pouch resealable plastic bag that holds seven (7) pairs of finished Medisox: Disposable Medicated Athlete's Foot Fungal Socks.
